(19) United States
(12) Patent Application Publication
(10) Pub. No.: US 2011/0210857 A1
(43) Pub. Date: Sep. 1, 2011

(54) SENSOR UNIT FOR CHECKING OF MONITORING AREAS OF DOUBLE-WALLED CONTAINERS OR DOUBLE-WALLED PIPELINES, OR DOUBLE-WALLED VESSELS

(75) Inventors: Jost-Henner Berg, Wilnsdorf (DE); Martin Hücking, Siegen (DE)

(73) Assignee: Sicherungsgerätebau GmbH, Siegen (DE)

(21) Appl. No.: 13/062,117

(22) PCT Filed: Sep. 9, 2009
(86) PCT No.: PCT/DE09/01255

§ 371 Date: May 2, 2011

(30) Foreign Application Priority Data
Sep. 14, 2008 (DE) 10 2008 047 257.3

(51) Int. Cl. G08B 21/00

(52) U.S. Cl. 340/605

(57) ABSTRACT

An apparatus for checking of monitoring areas (9) of double-walled containers (1), double-walled pipelines (7) or double-walled vessels by means of at least one pressure sensor (10) for measurement of the monitoring area internal pressure and by means of a media sensor (13) for detection of a medium in the monitoring internal area (6), characterized in that the apparatus determines a material constant K of the medium in the monitoring internal area (6), with the aid of the media sensor (13).

The present invention relates to apparatuses and systems for checking of monitoring areas of double-walled containers, double-walled pipelines and double-walled vessels.

The storage of stored materials, liquids or gas in containers or the transport of stored materials through pipelines always results in a risk of these stored materials being able to emerge because of leaks in the container system or in the pipelines. The emergence of the stored material now leads not only to losses of the stored material but can also lead to contamination of the environment if the container contents are toxic. In order to prevent the emergence of the stored material, not only are appropriately safely designed containers used, but preventative measures are additionally taken, which immediately initiate an alarm in the event of a leak. These leakage indication systems have been proven for monitoring of containers, pipes and vessels. They are successfully used in gas stations, tank depots and heating oil depots.

As a precaution against possible accidents of a different type, some containers, pipes or vessels are designed with double walls such that, in the event of a possible leak, the stored material, for example a fuel, cannot flow directly and without impediment into the environment. This has resulted in a further possibility of adopting a measure to prevent contamination of the environment caused by leaking containers and pipes. This is because the area between the two container walls, pipelines or vessels can be used as a monitoring area. A specific vacuum pressure is now formed in this monitoring area, and is measured by suitable pressure sensors. If the currently measured pressure (actual value) now differs from the desired pressure (nominal value), then this is measured by the pressure sensor. The information obtained in this way can then be processed and can lead to a reaction.

In addition to leak detection by pressure measurement, the Franklin Fueling Co. are currently also using a time measurement in order to find a possible leak.

A further product for leak detection in double-walled containers is offered by the Veeder-Root Co. In this case, in addition to the pressure measurement, a float is also introduced into the monitoring area, and indicates the presence of a liquid in the monitoring area.

However, the prior art has the disadvantage that the present measurement system cannot distinguish between a leak from the inner container wall or the outer container wall in the event of liquid ingress. This is because this may be ground water entering from outside or emerging liquid stored material, for example fuels or fuel mixtures. However, the second situation results in the risk of contamination of the environment. The damage must be rectified immediately. This is generally associated with rapid emptying of the container. A leak such as this therefore demands rapid, labor-intensive and therefore also very costly actions. A further major disadvantage of the prior art is the fact that no information is provided as to what substance has in this case already entered the monitoring area. However, knowledge about the substance that has entered and the container or pipe wall where the leak has occurred is of enormously major relevance for the preparatory measures to rectify the fault. This relates not only to the necessary schedule but also to the aids which are required to resume normal operation.

One object of the present invention is therefore to provide an apparatus which makes it possible to identify the substance entering the monitoring area, and from this to determine the wall where the leak has occurred.

According to the invention, this object is achieved by the apparatus for checking of monitoring areas of double-walled containers or double-walled pipelines or double-walled vessels by means of at least one pressure sensor for measurement of the monitoring area internal pressure and by means of a media sensor for detection of a medium in the monitoring internal area, wherein the apparatus determines a material constant K of the medium in the monitoring internal area, with the aid of the media sensor.

Double-walled containers, double-walled pipelines and double-walled vessels in principle only ever have one inner and one outer wall. The fundamental principle of the invention can, however, also be transferred to multiple-walled containers and pipes, without major difficulties, and all that is necessary is to determine precisely which walls should be the inner wall and the outer wall.

Furthermore, it is necessary to know the intermediate area in which the monitoring area is located. The terms double-walled and multiple-walled can be treated synonymously in these circumstances. The term vessel should also be interpreted widely for the purposes of this application thus, inter alia, covering the terms chute, entrances and troughs. This enumeration is only an example, and should in no way be understood as being exclusive.

A specific predetermined vacuum pressure is produced in order to find a leak by means of the apparatus according to the invention in the intermediate area between the two container, pipe or vessel walls, that is to say the container, pipe or vessel inner wall and the container, pipe or vessel outer wall, which is used as the monitoring area. The apparatus according to the invention is now connected to the monitoring area such that the pressure sensor can measure the pressure in the monitoring internal area. The measured pressure value (actual value) is now compared with the predetermined pressure value (nominal pressure value). If these two values (nominal pressure value and actual pressure value) differ from one another, then there is a leak in the monitoring area. When a vacuum pressure is applied, in the event of a leak in the container or pipe walls, either the medium which is located within the container or the pipe will flow into the monitoring area, or else the medium which is located outside the container, pipe or vessel will be sucked into the monitoring area at the location of this leak. This leads to a change in the internal pressure in the monitoring area. In addition to the pressure measurement, the apparatus uses a media sensor to determine a material constant K of the medium in the monitoring area. Material constants are constants which are intrinsic to a material at a constant temperature and constant pressure. They are governed by the physical characteristics of the material. Since different media or different materials in most cases have physical characteristics which differ from one another, they also each have different material constants. The media can therefore generally be distinguished by determining their material constants K. The medium in the double-walled container, pipe or vessel, the medium in the monitoring area, and the medium outside the container, pipe or vessel inherently have their own different material constants. This is particularly the case when fuels or fuel mixtures are located in the container or the pipe. Fuels or fuel mixtures are, of course, combustible, volatile hydrocarbons which apparently have different material constants in comparison to a lean air mixture which is present in the monitoring area, or in comparison to a solution, the majority of which is composed of ground water, and which is nonvolatile and difficult to ignite. Different density values, conductivity and polarity as well as flammability are particularly conspicuous here. If the material constant K of the fuel in the monitoring area is determined in this case, then the inner wall of the container, pipe or vessel is leaking. However, if the material constant K of an aqueous mixture is determined in the monitoring area, then the outer wall of the container, pipe or vessel has a leak, since ground water has entered. If no significant change is found in the determination of the material constant K over the time before the pressure change, then there is probably once again a leak in the outer wall of the container, pipe or vessel, since an air mixture has entered. The apparatus according to the invention can therefore be used to identify the substance which has entered and determine which of the two container walls has a leak.

The pressure sensor of the apparatus according to the invention must be able to measure the pressure in the conditions in the monitoring area. This can be done by many commercially available pressure sensors. For example, the pressure measurement can be carried out not only using passive pressure sensors, relative pressure sensors and absolute pressure sensors, but also difference-pressure sensors. Silicon, quartzes or metals may be used as sensor materials. It has now also become possible to use semiconductor technologies to apply piezo-electric thin films directly to measurement bodies. Zinc oxide (ZnO) or aluminum nitride (AlN) are generally used for this purpose.

For example, piezo-resistive pressure sensors can also be used. These generally contain a strain gage which is diffused in a membrane, and are predominantly produced from silicon. When a force is introduced, the resistance of the strain gages changes (because of the change in the length of the strain gages), and therefore the measured voltage. These pressure sensors can be produced at low cost and are comparatively highly sensitive. However, the materials which are used for pressure measurement are very highly dependent on the temperature. Sensors based on silicon therefore virtually always additionally have built-in temperature sensors which can be used to correct the measured-value information. It is also possible to use piezo-electric pressure sensors. In a piezo-electric sensor, an electrical voltage is produced in a crystal by charge separation by means of pressure. This is referred to as the piezo-electric effect. The pressure shifts ions in the interior of the crystal, as a result of which the charge varies in proportion to the force. However, piezo-electric sensors in principle measure only forces. If the aim is to use the sensor for pressure measurement purposes, the pressure must first of all be converted proportionally to a force via a membrane.

Capacitive pressure sensors, which contain a capacitor diffused in a silicon chip, can likewise be incorporated in the apparatus according to the invention. When pressure is applied across a membrane, the distance between the capacitor plates, and therefore the capacitance of the capacitor, changes. The capacitors are generally part of an internal amplifier, whose gain is dependent on the capacitance of the capacitor.

However, in the end, all pressure sensors convert the physical variable pressure to an electrical output variable which is proportional to the pressure.

The following is in general true, but should not be understood as being restrictive:

There is a defined vacuum pressure, the so-called operating vacuum pressure, in the monitoring area. This is, of course, greater than the pressure in a vacuum. A vacuum cannot, of course, build up any pressure, because of the lack of material. The pressure value in the vacuum-pressure state (operating vacuum pressure) is therefore greater than that in a vacuum. If the vacuum pressure (operating vacuum pressure) cannot be maintained in the monitoring area, because a medium is flowing in, then the pressure which currently exists in the monitoring area changes in the direction of the alarm pressure. The alarm pressure indicates a pressure value at which alarm signals are output. The alarm pressure value is not only higher than the pressure value in the vacuum but also higher than the pressure value at the defined vacuum pressure in the monitoring area, the operating vacuum pressure.

The media sensor is in practice chosen such that it can determine a material constant which is different for the media in question.

In another embodiment of the invention, the media sensor has at least two electrodes, and the apparatus uses the media sensor to determine an electrically measurable material constant K of the medium in the monitoring internal area.

This embodiment has the advantage that the apparatus can be produced easily and to be light in weight. Many sizes and shapes of electrodes have been investigated for their functionality and performance. These include planar electrodes, ring electrodes and rod electrodes manufactured from all possible types of metal, and even from graphite, to conventional, commercially available articles. With the electrically measurable material constants of the specific conductivity, the resistivity, a plurality of possible ways to distinguish between the media are at the same time provided with the aid of the respective material constant K. The measurement of the specific conductivity is suitable for distinguishing between a polar medium, in particular an aqueous solution, and a non-polar medium, in particular a hydrocarbon mixture.

In one particularly preferred embodiment of the apparatus according to the invention, the electrical material constant is the dielectric constant ∈. The dielectric constant ∈, in particular the relative dielectric constant ∈(r), is a material constant which is characteristic for each medium and denotes the ratio by which the capacitance of a capacitor which is filled with this medium rises in comparison to a capacitor filled with air. This is a non-dimensional number and, by definition, has the value 1 for air, and has a similar value for a vacuum. All liquids have a relative dielectric constant ∈(r) which has a value greater than 1. Water has the value 81, diesel fuel a value of 2.1, and an oil-water sludge mixture has a relative dielectric constant ∈(r) of 32 (all values relate to a measurement at 100 KHz). The relative dielectric constants ∈(r) of water and fuel accordingly differ from one another to a major extent, and it is therefore easily possible to distinguish between these two media by means of their relative dielectric constants ∈(r).

In a further very special embodiment of the apparatus for checking of monitoring areas, the relative dielectric constant ∈, in particular the relative dielectric constant ∈(r), is determined with the aid of a capacitance measurement, with this measurement preferably being carried out using a bridge circuit, in particular a Wheatstone bridge or a Schering bridge.

In one very particularly preferred embodiment of the present invention, the capacitance measurement is carried out by means of a Clapp oscillator method, preferably a modified Clapp-oscillator method. The Clapp oscillator method uses a transistor circuit which uses a very low voltage. In comparison to the previously used Meissner oscillator or Hartley oscillator, these circuits require only one coil without a tap. The resonant-circuit capacitor C is split into the three capacitors C1, C2 and C3. The high-frequency alternating voltage at the upper connection of C2 is twice as great as at the upper connection of C3. The voltage gain of the transistor of 0.99 and the voltage divider R3, R4 results in a total voltage gain of somewhat more than 1, as required for an oscillator. The resistors R1 and R2 govern the operating point of the transistor. The output signal of the oscillator is output via a fourth capacitor C4. The advantage of this embodiment is the high sensitivity for measurement of the dielectric constant ∈. It can even be determined through a cast material layer. The sheath on certain electrical components with a non-conductive encapsulating compound can be used to enhance safety. This is also important here, because fuels are also stored and conveyed in the containers, pipes and vessels.

In another embodiment of the present invention, this has at least one optocoupler which is used for potential isolation of each of the sensors from the other electrical components. An optocoupler is an optoelectronic composite component which consists of a component which generally emits infrared radiation and a component which receives the radiation. The two are protected against light and may be accommodated in a common housing. The purpose of optocouplers is to transmit an electrical signal while at the same time providing galvanic isolation (electrical isolation) between the input and output circuits. The optocoupler is used to convert possible input and output signals, in particular the measured values from the pressure sensor and the media sensor, to signals, which can then be transmitted to a receiving unit.

In one very special embodiment of the apparatus according to the invention, the optocoupler is designed to be intrinsically safe, preventing the optocoupler from being influenced by external voltage, while at the same time also providing explosion protection. However, the intrinsic safety of the optocoupler requires it to have its own cable supply and to be isolated from other circuits. The measures for protection against explosions and detonations of explosive stored material, in particular fuels and fuel mixtures, are legally controlled in many countries.

In a further embodiment of the invention, the pressure sensor and the media sensor are integrated in one unit. This results in advantages in production and in the fitting of the apparatus to installations, in particular tank installations.

In another embodiment of the invention, the unit has a housing and at least one valve, preferably a solenoid valve, in which case the valve controls the inlet and outlet flow of the medium to or from the monitoring area. The valve, preferably the solenoid valve, allows the medium to flow into the unit when in the open state. In the closed state, the medium cannot into the unit. The solenoid valve is opened when the pressure measured by the pressure sensor does not correspond to the operating vacuum pressure. After the solenoid valve has been opened, the pressure measurement may change, specifically when pressure equalization has taken place. If the operating vacuum pressure is present in the monitoring area, the pressure sensor once again now also measures the operating vacuum pressure. If there is a different pressure in the monitoring area, this is measured. If liquid enters the apparatus for checking of monitoring areas from the monitoring area, the solenoid valve is closed immediately. The sheathing of the unit into a housing makes the apparatus more robust, and therefore lengthens the life of the apparatus.

A further embodiment of the present invention is characterized in that—with the exception of the electrode parts of the media sensor which are in contact with the medium, and of the measurement sensor of the pressure sensor—the electrical components of the unit are surrounded by an electrically non-conductive encapsulating compound. The encapsulating compound need not, of course, adversely affect the operation of the apparatus according to the invention. For example, if electrode parts are intended to come into contact with the medium, then they must project out of the encapsulating compound. This is unnecessary in at least one of the embodiments of the invention proposed here, specifically the use of the Clapp oscillator method for measuring the dielectric constants. The sheathing with an encapsulating compound also prevents the emission of electrical charges, heat and other influences which the component can emit to its surrounding area, and therefore also to the medium, in particular fuel, which enters in the event of damage. The embodiment is therefore likewise used for protection against explosions.

In another embodiment of the apparatus according to the invention, the unit has an approximately cylindrical shape. This has the advantage of low-cost manufacture, which can be handled easily, and of making it easier to fit the component.

In one very preferred embodiment of the present invention, the unit has an adapter, preferably a coupling piece, via which the medium is supplied and which allows the connection of connection means, preferably hoses or pipes, for pneumatic coupling to a further unit or to the monitoring area. This embodiment of the apparatus according to the invention makes it easily possible to increase the number of components which are used to check the monitoring area. Further units, which use the same or different sensors, can be coupled to one another. The coupling piece between the apparatuses is now shaped such that the interior ensures a sufficient passage for the medium and projects to an adequate depth into the apparatus for checking of monitoring areas, such that the gap length and the gap width of the resultant gap between coupling piece and the housing of the apparatus comply with the respective explosion-protection requirements for zone isolation between the interior of the unit and the surrounding area. Furthermore, the coupling pieces must be able to connect the components to one another such that the existing vacuum pressure is maintained, that is to say the arrangement of the components in one or more rows does not lead to a new leak source. Otherwise, the pressure values produced by the pressure sensor are unusable since they do not indicate a leak in the container walls. Bayonet fittings, rotating closures and screw closures can be used as coupling pieces here. This embodiment of the apparatus for checking of monitoring areas is easy to handle and to fit.

The apparatus for checking of monitoring areas of double-walled containers, double-walled pipelines or double-walled vessels is, of course, used in a system which, in addition to the apparatus, has at least one double-walled container and/or at least one double-walled pipe and/or at least one double-walled vessel, at least one vacuum source which produces a vacuum pressure in the monitoring area and at least one alarm apparatus, wherein the apparatus for checking of monitoring areas is connected via a connection means to the monitoring area of the double-walled container, double-walled pipe, or double-walled vessel, and the apparatus for checking of monitoring areas is furthermore connected to at least one signal processing unit such that the latter can receive and process the signals produced by its pressure sensor and by the media sensor, in which case the signal processing unit is designed such that it compares the signals with predetermined values, in particular the pressure signal value with a pressure nominal value and the material constant signal value of the media sensor with a material constant nominal value, and uses this to produce new control data and control commands, in particular for the vacuum source and the alarm apparatus, and the vacuum source and the alarm apparatus are each designed such that they can carry out the control commands intended for them from the signal processing unit. The signal processing units may even already be present in the respective sensor, that is to say in the apparatus for checking of monitoring areas, changing this sensor to an intelligent sensor. However, the principle of data comparison of an actual value with a nominal value is maintained.

A system such as this is able to monitor the storage of fuels without any need to be concerned that the fuel can flow into the environment from the double-walled tank, the double-walled pipes or the double-walled vessels without this being noticed. The measured values obtained in the apparatus according to the invention, are, after processing, converted to control data and control commands, which can address and control all possible further controllable components. These components may now also be located outside the actual inventive system. If fuel is stored in a double-walled container, then it can be passed through a double-walled pipe. Both the double-walled container and the double-walled pipe may have a system for checking of monitoring areas. The control signals produced by the systems can now also be used by external apparatuses, thus making it possible to improve the operational safety of an entire feed installation. For example, a large number of processes can be automated, such that no faults resulting from human error can occur here. Underground tank installations in many cases elude checks and inspections by personnel directly on the system. In this case, a large proportion of the protection and inspection tasks must be carried out by a control unit, in order to ensure safety.

The vacuum source, in the simplest case a pump, produces the vacuum pressure in the monitoring area. It should preferably be designed such that it can be operated in such a way that a signal can be used to start it, to switch it off or to influence its power, as required. The alarm apparatus is used to produce alarms in the event of critical system states, in which case the alarm can be produced by visual, audible or other signals. Red alarm lamps are generally known, and loud siren noises as an alarm signal are also currently used. More discrete alarms are notifications via connected networks or by radio. These are likewise possible.

In a further embodiment of the system according to the invention, a plurality of components and apparatuses according to the invention are connected to one another via their connection means and are connected to the monitoring area or areas, with a hose and/or a pipe being used as the connection means. The advantage of this system is likewise the increased fail-safety resulting from redundancy achieved by equivalent, but differently configured, apparatuses according to the invention. However, it is also true here that the connection means can maintain the vacuum pressure, and that a normal weak point, specifically the ends of the connection pieces, are connected to other connection pieces or to the monitoring area, such that this prevents any change in the vacuum pressure in the monitoring area resulting from leaks at those ends.

In one embodiment of the system according to the invention, the vacuum source is a vacuum-buffer vessel, that is to say a vessel which can maintain the vacuum pressure after it has been evacuated. This vacuum-buffer vessel can on the one hand entirely or partially replace a pump as the vacuum source. It is preferably evacuated once again whenever the pump or else an immersed pump is run, in order to achieve the full functionality again. Any pump can be used to evacuate the vacuum-buffer vessel, that is to say pumps which do not belong to the system.

In a further embodiment of the system according to the invention, the system has a memory and monitor module which is designed such that it stores at least the signal values produced by the pressure sensor and/or by the media sensor and/or the pressure nominal value and/or the material constant nominal value and/or the control data produced by the signal processing unit, in each case over time. The advantage of this embodiment is that it is possible to call up the information about the current and previous operating states of the installation. For example, it is possible to better track problems resulting from insidious leaks, in order then to rectify them, if possible, without major effort. An insidious leak is identified by a slow increase in the rate of change of the pressure. It is also possible to estimate the size and the extent of the leak by the difference between the measured pressure values (nominal pressure value-actual pressure value).

The system according to the invention can be used for the storage of explosive and easily combustible media, in particular of fuels and fuel mixtures or diesel fuels, and for this reason it is advantageously designed to be explosion-proof and/or detonation-proof, preferably by the ends of the respective connection means between the monitoring area and/or the apparatus each being designed to be intrinsically explosion-proof and/or detonation-proof. This explosion proofing can be carried out on the one hand by reinforcement by means of fire-resistant insulation, but on the other hand it is also possible to use all other safety measures for explosion protection, for example isolation of all cable accesses, separate power supplies for each individual load in the system, or else other measures that are now known.

In one very particularly preferred embodiment of the system according to the invention, this system is characterized in that the signal processing unit is designed such that
in the situation in which the pressure signal from the pressure sensor is higher than the pressure nominal value (it can however still be lower than the alarm pressure value in absolute terms) and the material constant measured by the media sensor corresponds to a material constant nominal value which is equal to that material constant value of the medium in the container, pipe or vessel, the signal processing unit produces a control command for the alarm apparatus which initiates the alarm “PRODUCT LEAK”, as well as a control command for operating external apparatuses; and/or
in the situation in which the pressure signal from the pressure sensor is higher than the pressure nominal value (it can however still be lower than the alarm pressure value in absolute terms) and the material constant measured by the media sensor corresponds to a material constant nominal value which is equal to that material constant value of an aqueous mixture,
the signal processing unit produces a control command for the alarm apparatus which initiates the alarm “EXTERNAL LEAK, LIQUID”, and/or
in the situation in which the pressure signal from the pressure sensor is higher than the pressure nominal value (it is however higher than the alarm pressure value in absolute terms) and the material constant measured by the media sensor corresponds to a material constant nominal value which is not equal either to that material constant value of the medium in the container, pipe or vessel, or to that of an aqueous mixture,
the signal processing unit produces a control command for the alarm apparatus which initiates the alarm “AIR LEAK”.

For the simplest case, in which all measured values are within a range that is defined as being normal, no alarm messages are initiated. Only the standard messages, and possibly the routine reports, are generated by the signal processing unit, and are then output.

In the situation in which the installation is started and the operating vacuum pressure can then not be formed after a reasonable time, the alarm “AIR LEAK” is initiated. The lack of production of the vacuum pressure in the monitoring area may be due to a failure of the vacuum source and/or to a leak, which is probably not minor, on a container wall and/or a container pipe.

If the media sensor measures a material constant which is equal to that material constant value of the medium in the container or pipe, then the medium has entered the monitoring area. The inner container wall and/or the inner pipe wall is leaking. The entire installation, that is to say all the components of the system which can be operated by the control data and control commands, for example the vacuum source, the valve, preferably the solenoid valve, when this is designed such that it can be operated, receive the control data and control commands, stopping the installation as quickly as possible, but without damaging it. The alarm in this case is “PRODUCT LEAK”. This requires assistance as quickly as possible in order to rectify the damage. Furthermore, components which can be operated and are associated directly with the system can also be operated by the control data, and their operation can then even be stopped. For example, the operation of an external feed pump in a double-walled feed pipe may be interrupted when the system for checking of monitoring areas in the double-walled feed pipe has emitted the alarm “PRODUCT LEAK”.

If the pressure signal from the pressure sensor is higher than the nominal pressure value, and the material constant measured by the media sensor additionally corresponds to a material constant nominal value which is equal to that material constant value of an aqueous mixture, then ground water has entered the monitoring area. The vacuum source can attempt to maintain the vacuum pressure, which may still be possible if the damage to the wall is minor, but the signal processing unit produces a control command for the alarm apparatus, which initiates the alarm “EXTERNAL LEAK, LIQUID”. This means that the preparations are taken to repair the leak. However, the installation continues to run, because operation and the environment are not immediately endangered.

If the pressure signal from the pressure sensor is higher than the nominal pressure value and the material constant measured by the media sensor corresponds to a material constant nominal value which is not equal either to that material constant value of the medium in the container, pipe or vessel, nor to that of an aqueous mixture, then an air leak has occurred. This damage situation also need not necessarily lead to the entire installation being stopped, but the signal processing unit produces a control command for the alarm apparatus, which initiates the alarm “AIR LEAK”.

These evaluations of the output information make it possible to produce an assessment of the situation in the event of a pressure change in the monitoring area, which makes it possible to optimally select the time, action and handling procedure to rectify the leaks, that is to say in the event of damage.

These procedures may even require drastic actions, because it is always possible to additionally install the sensors in the apparatus according to the invention such that the installation will be stopped immediately when precisely defined values occur, that is to say without previous processing of the values by the signal processing unit.

The system according to the invention can also be used for storage of fuels.

Exemplary embodiments, which should not be understood as being restrictive, will be described in the following text with reference to the drawing, in which:

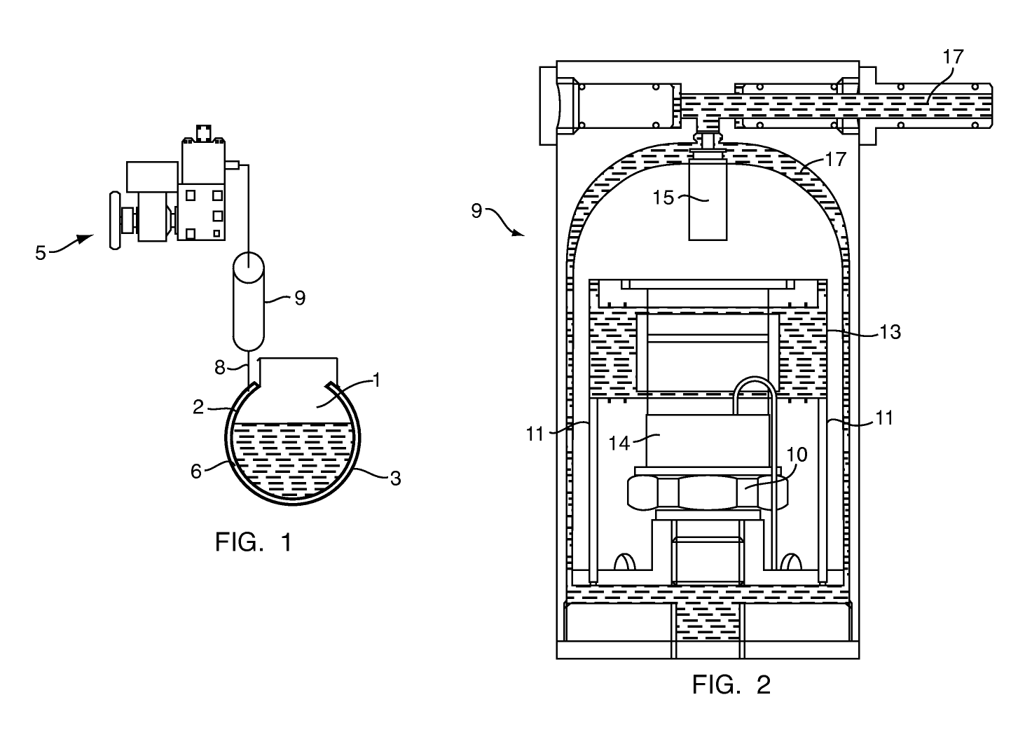

FIG. 1 shows a schematic illustration of the system according to the invention,

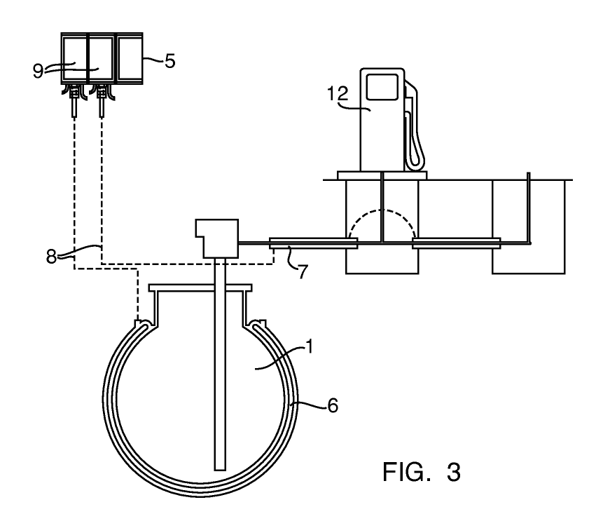

FIG. 2 shows a schematic illustration of the apparatus according to the invention, and

FIG. 3 shows a schematic illustration of the system according to the invention, for use for receiving, storing and supplying fuels.

FIG. 1 shows, schematically, an illustration of the system according to the invention for checking of monitoring areas of double-walled containers 1, double-walled pipes or double-walled vessels, for an installation for fuel storage. These are mounted in a double-walled container 1. The figure clearly shows the inner container wall 2 and the outer container wall 3. The pump 5 is located on the left-hand side of the container (as viewed by the observer). This pump 5 produces a vacuum pressure in the area between the inner container wall 2 and the outer container wall 3, that is to say in the monitoring area 6. The pump 5 is connected to the monitoring area 6 of the container by means of a pipe connection which is in the form of a pneumatic connection means. The apparatus according to the invention for checking of monitoring areas 9 is located in this pipe connection. The pump 5 therefore sucks the medium out of the monitoring area 6 through the apparatus for checking of monitoring areas 9. When liquid is sucked in and is passed into the apparatus for checking of monitoring areas 9, it cannot, however, enter the pump 5 since, after detection of the liquid, the solenoid valve is closed immediately. An upstream auxiliary device, preferably connected via a three-way cock, can also be fitted under the apparatus for checking of monitoring areas 9. This auxiliary device may be connected to a manometer or else may be used only for ventilation after liquid has entered the apparatus for checking of monitoring areas 9. The signal processing unit, which is designed such that it compares the signals with predetermined values, in particular the pressure signal value with a nominal pressure value and the material constant signal value from the media sensor with a material constant nominal value, and produces new control data and control commands therefrom, in particular for the vacuum source and the alarm apparatus, is not shown in this figure. It may also be in a split form, specifically in each case in the sensors and also outside the unit.

A vacuum pressure is now formed and maintained in the monitoring area 6 of the double-walled container 1, with the aid of the pump 5. The value of the monitoring area internal pressure (actual pressure value) is measured by the pressure sensor 10 in the apparatus according to the invention for checking of monitoring areas 9, and is compared with the predetermined pressure (nominal pressure value, that is to say the operating vacuum pressure which can invariably be defined in a range with an upper and lower nominal operating pressure value). If all the measured values obtained and the data produced therefrom with the aid of the signal processing unit are in the “normal” range, a possible command “observe further” is proposed, which is implemented either manually or automatically by the open-loop and closed-loop control apparatuses in the installation. The measured values and data are actually in the normal range when the pressure difference between the nominal pressure and the actual pressure does not exist at all or is only minor, that is to say the alarm pressure has not been reached. The alarm pressure must be at least 30 mbar higher than the pressure which results from the geodetic height different between the apparatus for checking of monitoring areas 9 and the lowest point in the double-walled container 1. However, if the desired operating vacuum pressure has not been reached within a reasonable time after starting of the installation, that is to say the alarm pressure (which is considered to be an absolute pressure) has not been undershot, then the alarm “AIR LEAK” is initiated. The number of fault possibilities is too great, and the risk is unacceptable. For example, a defective pump 5 may itself be responsible for the lack of vacuum pressure. However, there may just as well be a leak in the outer container wall 3 or the inner container wall 2.

In the case of an air leak, air is sucked into the monitoring area 6 of the double-walled container 1. The measured pressure (actual pressure value) will in consequence differ from the operating vacuum pressure. The pump 5, preferably a vacuum pump, is switched on in order to produce the operating vacuum pressure again. If this is impossible, because of a relatively major air leak, as a result of which more air enters the monitoring area 6 than the pump 5 can remove from it, then the pressure value defined as the alarm pressure will be exceeded after some time. If the media sensor does not exhibit any change in the capacitance value, then there is no liquid in the monitoring area 6. The signal processing unit produces a control command for the alarm apparatus, which initiates the alarm “AIR LEAK”. This alarm does not lead to an acute installation disturbance, and in particular not necessarily to the external controllable apparatuses being switched off, for example the feed pump which is required for feeding the product (for example fuel). Since the desired vacuum pressure admittedly cannot be formed, but a sufficient vacuum pressure is still available, there is therefore no risk to the environment. The damage should be rectified in a reasonable time.

In the case of a liquid leak, either fuel or ground water is sucked into the monitoring area 6. In this case as well, the pump 5 is switched on, in order to maintain the vacuum pressure. However, in this case, the media sensor 13 now detects a liquid in the monitoring area 6. It is possible to distinguish between the fuel and the ground water by the different dielectric constants ∈ of the fuel and of the water. Over the course of time, either the fuel or the ground water is sucked into the connection between the container and the pump 5. Two different situations must now be considered.
a) If the apparatus according to the invention for checking of monitoring areas 9 measures the capacitive value of water, then it is certain that the outer container wall 3 is leaking. Contamination of the surrounding area by stored material being released can thus also be precluded. The alarm apparatus can output the alarm “EXTERNAL LEAK, LIQUID”. The entire installation, for example an installation for feeding fuel from a double-walled container 1 via a double-walled pipe, can continue to run. The feeding of the fuel is not adversely affected by the ingress of ground water into the monitoring area 6 of the double-walled container or of the double-walled pipe. The fuel feed pump, preferably an immersed pump, can therefore continue to run and feed fuel, until the repair is carried out within a reasonable time. In fact, the installation can continue to run until it has to be stopped for the repair to be carried out.
b) If the media sensor 13 in the apparatus according to the invention for checking of monitoring areas 9 measures the capacitive value of the fuel, then there is undoubtedly a leak in the inner container wall 2. This can also lead to possible contamination of the surrounding area by stored material being released. In this situation, the pump power can also be increased until the signal processing unit produces a control command to stop the vacuum source and a control command for the alarm apparatus, which initiates the alarm “PRODUCT LEAK”, as well as a control command to operate the external controllable apparatus, that is to say the feed pump as well. However, in the event of a product leak and when using pressure pumps, a rapid pressure rise in the monitoring area 6 can occur in a double-walled pipe. In this situation, in order to protect the environment, a control command is passed to all controllable components in the system or else the entire installation, in order to switch them off, specifically inter alia by the following measures: switching off the pressure pumps for feeding the medium into the double-walled monitored pipes, switching off the vacuum source, closing the solenoid valve. This should be done without damaging the installation.

FIG. 2 shows the fundamental design of the apparatus according to the invention. This figure clearly shows the pressure sensor 10. Because it makes direct contact via the connection means with the monitoring area 6, this measures the same pressure values for the medium 17 as those values which exist in the monitoring area 6. The cylindrical electrodes 11 of the media sensor 13 are located around the pressure sensor 10. In this case, the optocoupler 14, which provides the signal output and signal reception, is situated above the pressure sensor 10. For better protection against possible explosions and detonations, the entire internal area of the sensor unit is encapsulated with an encapsulating compound, for example WEVO PU 403 FL with 300 RE hardener, or MEWA ME-ISO PUR K 760. Furthermore, a solenoid valve 15 is also provided and controls the inlet and outlet of the medium 17 to and from the monitoring area 6.

FIG. 3 shows a schematic illustration of the system according to the invention in installations for use for receiving, storing and outputting fuels.

This figure clearly shows the apparatuses for checking of monitoring areas 9. The pump 5 produces the vacuum pressure in the monitoring area 6 of the double-walled container 1 and in the monitoring area of the double-walled pipeline 7. The pipe connection 8 is in the form of a pneumatic connection means. The respective monitoring areas are connected to the pump 5 via the apparatus according to the invention. The double-walled container 1 is connected via at least one double-walled pipeline 7 to at least one gasoline pump 12.

1-24. (canceled)

25. A system for checking of monitoring areas (6) of double-walled containers (1) or double-walled pipes (7) or double-walled vessels, having at least
one double-walled container (1) and/or at least one double-walled pipe (7) and/or at least one double-walled vessel, at least one vacuum source which produces a vacuum pressure in the monitoring area or areas (6),
an apparatus for checking of monitoring areas (9) of double-walled containers (1) or double-walled pipelines (7) or double-walled vessels by means of at least one pressure sensor (10) for measurement of the monitoring area internal pressure and by means of a media sensor (13) for detection of a medium in the monitoring internal area (6), wherein the apparatus determines a material constant K of the medium in the monitoring internal area (6) with the aid of the media sensor (13), as well as
at least one alarm apparatus, wherein
the apparatus for checking of monitoring areas (9) is connected via a connection means to the monitoring area or areas (6) of the double-walled container (1), double-walled pipe (7), or double-walled vessel,
the apparatus for checking of monitoring areas (9) is furthermore connected to at least one signal processing unit such that the latter can receive and process the signals produced by its pressure sensor (10) and by the media sensor (13), in which case
the signal processing unit is designed such that it compares the signals with predetermined values, in particular the pressure signal value with a pressure nominal value and the material constant signal value of the media sensor (13) with a material constant nominal value, and uses this to produce new control data and control commands, in particular for the vacuum source and the alarm apparatus,
in that the signal processing unit
in the situation in which the pressure signal from the pressure sensor (10) is higher than the pressure nominal value and the material constant measured by the media sensor (13) corresponds to a material constant nominal value which is equal to that material constant value of the medium (17) in the container, pipe or vessel,
produces a control command for the alarm apparatus, which initiates the alarm “PRODUCT LEAK”, as well as a control command for operating external apparatuses, and/or
in the situation in which the pressure signal from the pressure sensor (10) is higher than the pressure nominal value and the material constant measured by the media sensor (13) corresponds to a material constant nominal value which is equal to that material constant value of an aqueous mixture,
produces a control command for the alarm apparatus, which initiates the alarm “EXTERNAL LEAK, LIQUID”, and/or
in the situation in which the pressure signal from the pressure sensor (10) is higher than the pressure nominal value and the material constant measured by the media sensor (13) corresponds to a material constant nominal value which is not equal either to that material constant value of the medium (17) in the container, pipe or vessel, or to that of an aqueous mixture,
produces a control command for the alarm apparatus which initiates the alarm “AIR LEAK”, and
the vacuum source and the alarm apparatus are each designed such that they can carry out the control commands intended for them from the signal processing unit.

26. The system as claimed in claim 25, characterized in that a hose and/or a pipe is used as the connection means between the monitoring area (6) and the respective apparatus for monitoring of monitoring areas (9).

27. The system as claimed in claim 25, characterized in that the vacuum source is a pump (5).

28. The system as claimed in claim 25, characterized in that the vacuum source is a vacuum-buffer vessel.

29. The system as claimed in claim 25, characterized in that the system has two vacuum sources, in which case the first vacuum source is a vacuum-buffer vessel and the other vacuum source is a pump (5).

30. The system as claimed in claim 25, characterized in that the system has a memory and monitor module which is designed such that it stores at least the signal values produced by the pressure sensor (10) and/or by the media sensor (13) and/or the pressure nominal value and/or the material constant nominal value and/or the control data produced by the signal processing unit, in each case over time.

31. The system as claimed in claim 30, characterized in that the values stored over time can be called up and can be output on an output unit.

32. The system as claimed in claim 25, characterized in that the media sensor (13) of the apparatus for monitoring of monitoring areas (9) of double-walled containers (1), double-walled pipelines (7) or double-walled vessels has at least two electrodes (11), and the apparatus for checking of monitoring areas (9) of double-walled containers (1), double-walled pipelines (7) or double-walled vessels uses the media sensor (13) to determine an electrically measurable material constant K of the medium (17) in the monitoring internal area (6).

33. The system as claimed in claim 32, characterized in that the electrical material constant is the dielectric constant ∈.

34. The system as claimed in claim 33, characterized in that the dielectric constant ∈ is determined by a capacitance measurement.

35. The system as claimed in claim 34, characterized in that the capacitance measurement is carried out by means of a bridge circuit, preferably a Wheatstone bridge or a Schering bridge.

36. The system as claimed in claim 34, characterized in that the capacitance measurement is carried out by means of a Clapp oscillator method, preferably a modified Clapp-oscillator method.

37. The system as claimed in claim 32, characterized in that the apparatus for checking monitoring areas (9) of double-walled containers (1), double-walled pipelines (7) or double-walled vessels has at least one optocoupler (14) which is used for potential isolation of each of the sensors from the other electrical components.

38. The system as claimed in claim 37, characterized in that the optocoupler (14) is designed to be intrinsically safe.

39. The system as claimed in claim 32, characterized in that the pressure sensor (10) and media sensor (13) are integrated in one unit.

40. The system as claimed in claim 39, characterized in that the unit has a housing and at least one valve (15), preferably a solenoid valve, in which case the valve (15) controls the inlet and outlet flow of the medium (17) to or from the monitoring area (6).

41. The system as claimed in claim 39, characterized in that the electrical components of the unit are surrounded by an electrically non-conductive encapsulating compound.

42. The system as claimed in claim 39, characterized in that the unit has an approximately cylindrical shape.

43. The use of a system as claimed in claim 25 for checking of monitoring areas of double-walled containers (1) or pipelines (7) in installations which are used for the storage of fuels.
